(19) United States
(12) Patent Application Publication
(10) Pub. No.: US 2009/0325699 A1
(43) Pub. Date: Dec. 31, 2009

(54) INTERFACING WITH VIRTUAL REALITY

(76) Inventor: Leonidas Delgiannidis, Lexington, MA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/446,802

(22) PCT Filed: Oct. 31, 2007
(86) PCT No.: PCT/US07/83097

§ 371 Date: Apr. 23, 2009

Related U.S. Application Data
(60) Provisional application No. 60/856,709, filed on Nov. 3, 2006.

(51) Int. Cl. A63F 13/00

(52) U.S. Cl. 463/32

(57) ABSTRACT

Included are embodiments for implementing virtual reality. More specifically, one embodiment of a virtual reality method includes interfacing with host game logic, the host game logic configured to provide an interactive video game interface and receiving display data from the host game logic, and provide the display data to a virtual reality head mounted display. Some embodiments include receiving user motion input to control at least a portion of the interactive video game interface, the user motion too input being provided via a virtual simulation device, the virtual simulation device configured to facilitate control of at least a portion of the interactive video game interface via simulation of user motion and translating the received user motion input into a format for controlling the interactive video game interface. Still some embodiments include providing the translated user motion input to the host game logic.

### CROSS REFERENCE

This application claims the benefit of U.S. Provisional Application Number 60/856,709, filed Nov. 3, 2006, which is incorporated by reference in its entirety.

### BACKGROUND

Today's video games are becoming more realistic and more computationally expensive. Artificial Intelligence, multi-texturing, physics, lighting effects, three-dimensional (3D) sound, etc. make 3D desktop games attractive, and the player's experience immersive. An immersive virtual environment includes multiple sources of feedback for a user to create the sensation that the user is fully immersed in the virtual environment. To accomplish such realistic environments, high-end rendering game engines have been designed that require powerful GPUs, high-end sound cards, and power-thirsty processors. Although these games are designed to be played primarily with a keyboard and a mouse, other devices such as joysticks, steering wheels, pedals, etc., can be incorporated.

Normally, 3D desktop first-person-view shooting games are played in front of a computer monitor where the user is sitting in a chair and using his or her mouse and keyboard to simulate actions such as jumping, crouching, shooting, walking, zooming-in to the enemy, etc. Even though the game's graphics and sound are very realistic and convincing, user experience can be improved.

### SUMMARY

Included are embodiments for implementing virtual reality. More specifically, one embodiment of a virtual reality method includes interfacing with host game logic, the host game logic configured to provide an interactive video game interface and receiving display data from the host game logic, and provide the display data to a virtual reality head mounted display. Some embodiments include receiving user motion input to control at least a portion of the interactive video game interface, the user motion input being provided via a virtual simulation device, the virtual simulation device configured to facilitate control of at least a portion of the interactive video game interface via simulation of user motion and translating the received user motion input into a format for controlling the interactive video game interface. Still some embodiments include providing the translated user motion input to the host game logic.

Also included are embodiments of a system. At least one embodiment of a system includes an interface component configured to interface with host game logic, the host game logic configured to provide an interactive video game interface and a first receive component configured to receive display data from the host game logic, and provide the display data to a virtual reality head mounted display. Some embodiments of a system include a second receive component configured to receive user motion input to control at least a portion of the interactive video game interface, the user motion input being provided via a virtual simulation device, the virtual simulation device configured to facilitate control of at least a portion of the interactive video game interface via simulation of user motion and a translate component configured to translate the received user motion input into a format for controlling the interactive video game interface. Some embodiments include a provide component configured to provide the translated user motion input to the host game logic.

Also included are embodiments of a computer readable storage medium. At least one embodiment of a computer readable storage medium includes interfacing logic configured to interface with host game logic, the host game logic configured to provide an interactive video game interface and first receiving logic configured to receive display logic configured to display data from the host game logic, and provide the display data to a virtual reality head mounted display. Some embodiments include second receiving logic configured to receive user motion input to control at least a portion of the interactive video game interface, the user motion input being provided via a virtual simulation device, the virtual simulation device configured to facilitate control of at least a portion of the interactive video game interface via simulation of user motion and translating logic configured to translate the received user motion input into a format for controlling the interactive video game interface. Still some embodiments include providing logic configured to provide the translated user motion input to the host game logic.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram illustrating an embodiment of a virtual simulated rifle (VSR).

FIGS. 2-3 is a diagram illustrating a user operating the VSR.

FIG. 4A is a block diagram of an embodiment of a computer system used in conjunction with the VSR.

FIG. 4B is a block diagram of an embodiment of a software interface to the VSR.

FIG. 5 is schematic diagram of an embodiment of a virtual reality (VR) system incorporating the computer system and VSR.

FIG. 6 is a diagram illustrating an exemplary graphical user interface (GUI) implemented by the VR system shown in FIG. 5.

FIG. 7 depicts a flowchart illustrating a process that may be utilized for providing virtual reality controls, such as described with reference to FIG. 5.

FIG. 8 depicts a flowchart illustrating a process for providing user motion input to a host game, similar to the flowchart from FIG. 7.

### DETAILED DESCRIPTION

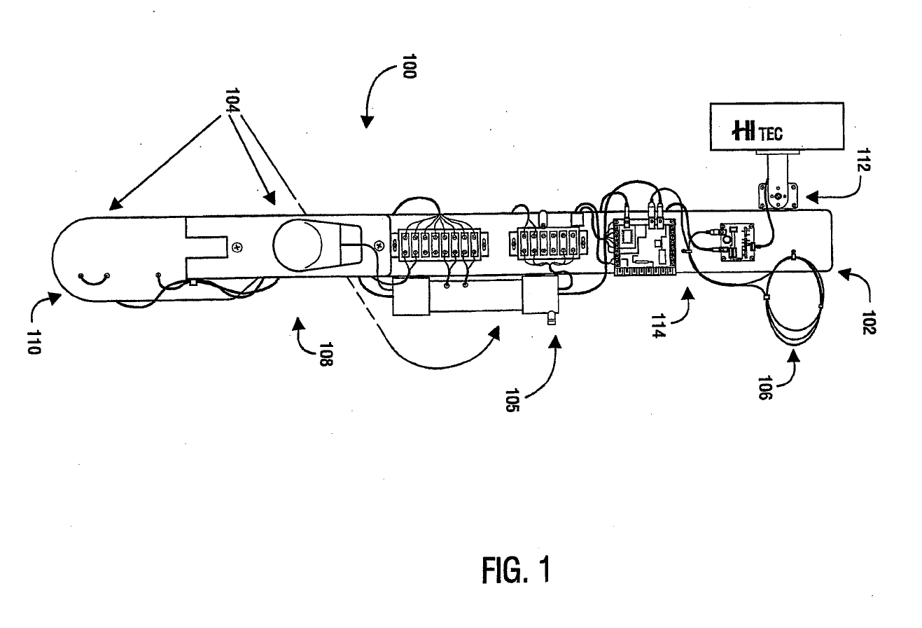

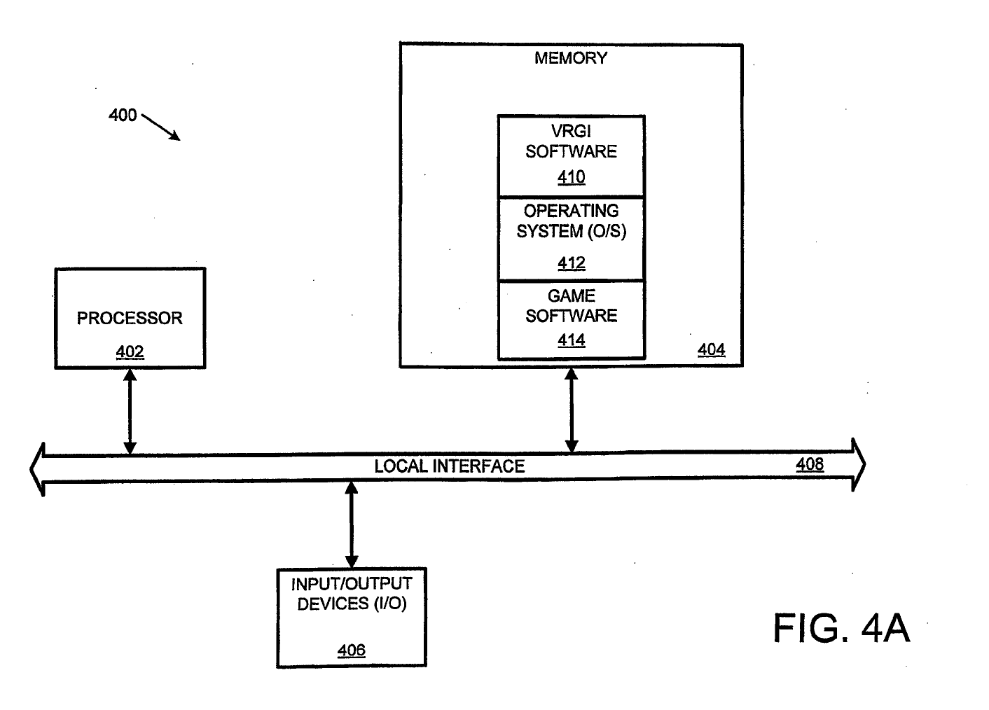

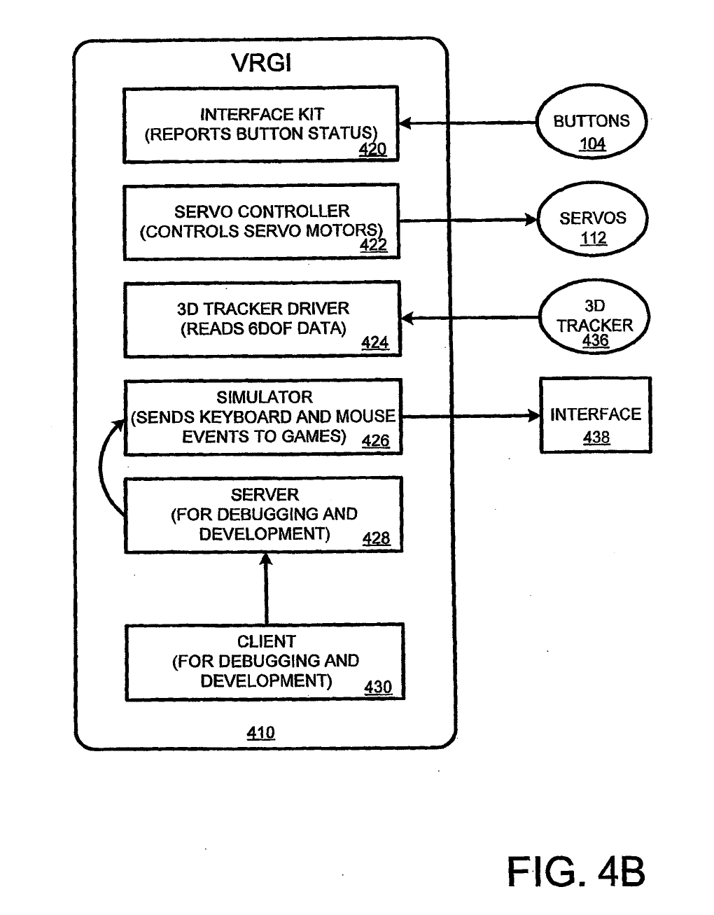

Various embodiments of virtual reality systems and methods are disclosed (herein, collectively referred to simply as VR system(s)). One embodiment of a VR system comprises Virtual Reality Game Interface (VRGI) software (see element 410, FIG. 4, also referred to as simply VRGI) that is configured to provide an interface to conventional three dimensional (3D) desktop first-person-view shooting games (herein, also referred to as host game software). The VRGI 410 may be configured to enable users to play commercial 3D first-person-view shooting games in an immersive environment. The VRGI 410 may be configured to interface with these commercial games by simulating mouse and keyboard events, as well as other peripheral device events (herein, also generally referred to as user input events). Such VR system embodiments may also include an interaction device, such as a Virtual Simulated Rifle (see element 100, FIG. 1, also referred to as VSR) that is used to play the games in a virtual environment. The VSR 100 may be utilized to replace the mouse, keyboard, joystick, and/or other peripheral devices (herein, also generally referred to as user input devices) found in a common desktop for playing a 3D game.

Conventional systems are typically designed to work for a specific 3D game and not for general, first-person-view shooting games. Many of these systems are implementation-specific (e.g., designed for a particular game), and may require code modification to work with other games. On the other hand, VRGI 410 does not require any modification of game code. That is, VRGI 410 works as a wrapper around the “real” game. This enables one to play any or substantially any 3D first-person-view shooting game (or other games) in virtual reality.

Experiments were conducted to compare performance between playing a 3D game the conventional way (e.g., using a keyboard and a mouse), and by playing the same game in a virtual environment using the VRGI software 410 and the VSR 100. Experimental results show that playing the same desktop 3D game in a virtual environment is more challenging than conventional methods, yet may provide users with greater satisfaction and enjoyment. Experiments have shown that moving in virtual environments using VRGI 410 requires minimal training; users can learn how to use the device within minutes.

In at least one embodiment, force feedback is provided by an off-balance weight controlled by servo motors that are attached to the VSR 100 for enhanced realism while firing. A mini push-button attached to the butt of the gun allows the user to zoom while looking through a virtual riflescope. Via 3D tracking of the user's head, VRGI 410 makes the game experience more immersive because the player's movement in the game is dependent on their actions in physical space. This makes the game more immersive than a traditional game because the user needs to physically move instead of hitting a key on the keypad to execute a movement, for example.

The VRGI 410 enables a user to easily and naturally interact in 3D game environments. Instead of playing a game through traditional input devices (mouse, keyboard, joystick, etc.), the VRGI 410 allows the user to step into the environment and play the game in virtual space. The VRGI 410 may be configured as a software package that runs in parallel with existing commercial games and allows the user(s) to play these games in an immersive environment. Anything that the game's engine and the game itself support via a mouse and a keyboard is also supported in VRGI 410. Since an immersed user does not have access to the mouse, the keyboard, or a joystick, VSR 100 provides a mechanism that enables a player to interact with the game.

Although described in the context of a VSR 100, it will be understood in the context of this disclosure by those having ordinary skill in the art that other interaction devices can be employed in some embodiments. That is, although the VRGI 410 is described in the context of first-person-view shooting games, it can be extended to other 3D desktop games such as car games, among other games.

The Virtual Simulated Rifle (VSR) 100 shown in FIG. 1 is an interaction device and includes, in at least one embodiment, of a wooden frame 102, a set of push-buttons 104, two servo motors 112 and the electronics to control the servos 112 and detect the state of the buttons 104. One having ordinary skill in the art will understand that other materials of construction (e.g., plastic, metal, etc.) and other switching methods (e.g., lever-type switches, etc.) may be used in some embodiments. The electronics, buttons 104 and the servos 112 may be mounted onto (or integrated into in some embodiments) the VSR frame 102. In at least one embodiment, a USB cable and a 6VDC cable 106 used in powering the electronics connects the VSR 100 with a host computer (see element 400 FIG. 4).

Similarly, in some embodiments, wireless communication between the host computer 400 and the VSR 100 may be implemented, and/or power generation using 6 VDC or other voltages may be self-contained (e.g., on or within the frame of the VSR 100), thus obviating (or reducing) the use of wired connections. The state of the buttons is detected, in at least one embodiment, by a Phidgets interface kit, and the servo motors 112 are controlled by a Phidgets servo controller, which is attached to the interface kit. One having ordinary skill in the art will understand that other interface kits and/or servos (or other motors) may be implemented in some embodiments.

In at least one embodiment, there are at least three push-buttons 104 on the VSR 100. The first button 105, when pressed, makes the virtual self walk forward. This first button 105 is located near the center at the bottom of the VSR 100 where the user places his/her left hand to hold on to it. A second button 108 (e.g., shown using a modified computer mouse, although one having ordinary skill in the art would appreciate that other like-interface mechanisms may be employed in some embodiments) provides functionality as the VSR 100 trigger. When the user presses either one of the two mouse buttons 108, the VRGI sends a “CTRL” key-press event to the host computer, causing the weapon to fire in the game. If the user holds the firing button 108 down the VSR 100 will continue to fire until they release the mouse button 108. A third button 110 is a low profile push-button and it is placed at the butt of the VSR 100. This button 110 is used for zooming in the environment. The user can look through the virtual riflescope by placing the butt of the weapon on their shoulder, to see the enemy up close in which case this button 110 is pressed. The user will stay zoomed in as long as the VSR 100 is pressed to the user's shoulder. When the user moves the VSR 100 back to the normal position by their side, the view will zoom back out. One having ordinary skill in the art will understand that the locations of the various buttons and other components can be in different locations in some embodiments.

When the user fires the VSR 100 by pressing the buttons 108, a feedback mechanism is activated. The feedback mechanism includes a servo controller and two mechanically aligned servo motors 112 that are wired to receive the same signal from a servo controller to handle the weight of the off-center weight mounted on them. When the user fires the VSR 100, the VSR 100 responds by moving the weight forward and backward providing the force sensation of a firing weapon.

In addition to the plurality of extra switches used for debugging and during development, there may be a plurality of light emitting diodes 114 (LEDs) connected to the interface kit that provide visual feedback, to the developer, of the state of the VSR 100 (e.g., the VSR 100 is connected to the USB port, USB ports are opened via software, 3D tracking is enabled, etc.).

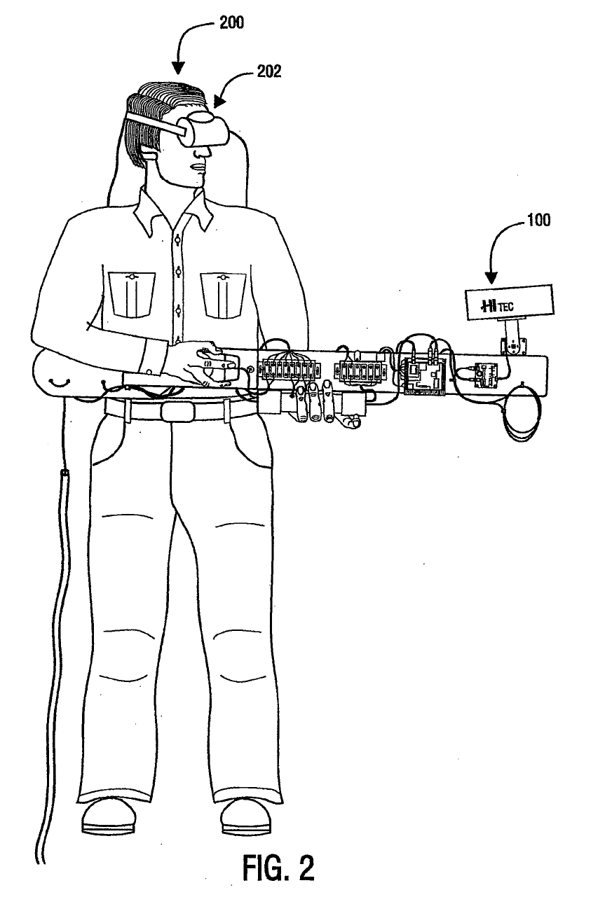

At initialization, VRGI 410 initializes an internal variable to the height of the user using the height information from the 3D sensor 202 while the user is standing as shown in FIG. 2.

More specifically, FIG. 2 illustrates the VSR 100 and a head mounted display (HMD) 200. More specifically the user can place the HMD 200 over the user's eyes. The HMD 200 may be configured to communicate with the VRGI 410 to provide the display, as provided by the game. Additionally, the HMD 200 may be configured with positioning and/or motion sensors to provide game inputs (e.g., user motion inputs) back to the VRGI 410.

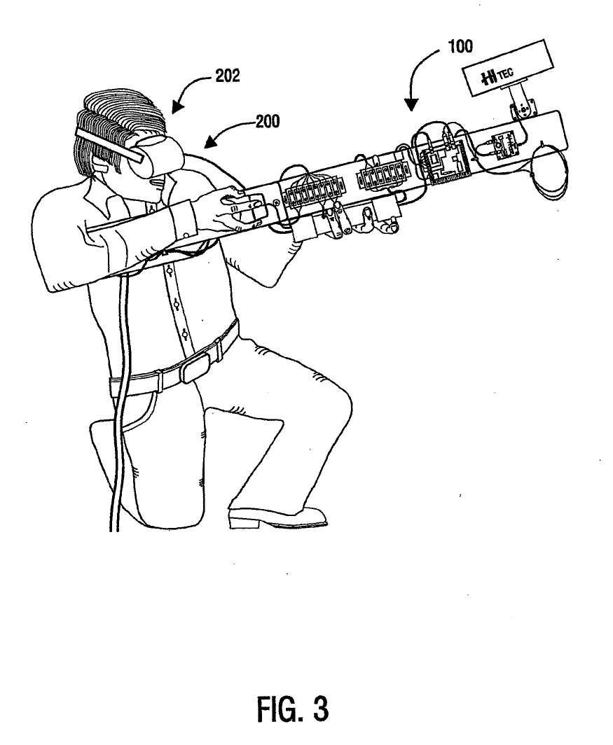

FIG. 3 is a diagram illustrating the user crouching during game play, similar to the diagram from FIG. 2. As shown in FIG. 3, when the user crouches, the character (virtual self) in the game crouches. More specifically, the HMD 200 and/or the VSR 100 may include one or more sensors 202 for determining when the current height of the user becomes lower than the initial height minus an empirically set threshold. Similarly, when the user physically jumps, another key-press event is generated to make the character (virtual self jump in the game. In all games experimented with, the games provide an interface to map keyboard buttons and mouse events to specific actions. This behavior is then mapped in the VRGI 410 to produce identical actions. While some embodiments may include tracking a user's head movement and position, some embodiments may track the VSR 100 and/or the user's head position.

FIG. 4A is a block diagram of an embodiment of a computer system 400 (e.g., host computer) used in conjunction with the VSR 100. The host computer 400 generally includes a processor 402, memory 404, and one or more input and/or output (I/O) devices 406 (or peripherals, such as the VSR 100 or components contained therein) that are communicatively coupled via a local interface 408. The local interface 408 may be, for example, one or more buses or other wired or wireless connections. The local interface 408 may have additional elements such as controllers, buffers (caches), drivers, repeaters, and receivers, to enable communication. Further, the local interface 408 may include address, control, and/or data connections that enable appropriate communication among the aforementioned components.

The processor 402 is a hardware device for executing software, particularly that which is stored in memory 404, such as VRGI Interface software 410 and/or an operating system 412. The processor 402 may be any custom made or commercially available processor, a central processing unit (CPU), an auxiliary processor among several processors associated with the processing device, a semiconductor-based microprocessor (in the form of a microchip or chip set), a macroprocessor, or generally any device for executing software instructions.

The memory 404 may include any one or combination of volatile memory elements (e.g., random access memory (RAM)) and nonvolatile memory elements (e.g., ROM, hard drive, etc.). Moreover, the memory 404 may incorporate electronic, magnetic, optical, and/or other types of storage media. Note that the memory 404 may have a distributed architecture in which where various components are situated remotely from one another but may be accessed by the processor 402.

The software in memory 404 may include one or more separate programs, each of which comprises an ordered listing of executable instructions for implementing logical functions. In the nonlimiting example of FIG. 4A, the software in the memory 404 includes VRGI software 410 for providing one or more of the functionalities described herein. As a nonlimiting example, the VRGI software 410 may include interfacing logic 410a configured to interface with the game software 414, where the game software is configured to provide an interactive video game interface 438 (FIG. 4B). The VRGI software 410 may also include first receive logic 410b configured to receive display data from the game software 414 and provide display data to the HMD 200. The VRGI software 410 may also include second receive logic 410c configured to receive user motion input to control at least a portion of the interactive video game interface 438, where the motion input is provided via the VSR 100. The VSR 100 may be configured to facilitate control of at least a portion of the interface 438 via simulation of user motion. Also included is translate logic 410c configured to translate the received user motion into a format for controlling the interface 438. Also included is provide logic configured to provide the translated user motion input to the game software 414.

The memory 404 may also include a suitable operating system (O/S) 412. The operating system 412 may be configured to control the execution of other computer programs, such as control software, and provides scheduling, input-output control, file and data management, memory management, and communication control and related services. The memory 404 may also include game software 414 for providing the video game interface.

The VRGI software 410 may be configured as a source program, executable program (object code), script, or any other entity that includes a set of instructions to be performed. The VRGI software 410 can be implemented, in at least one embodiment, as a distributed network of modules, where one or more of the modules can be accessed by one or more applications or programs or components thereof. In some embodiments, the VRGI software 410 can be implemented as a single module with all of the functionality of the aforementioned modules. When the VRGI software 410 may be a source program, then the program(s) may be translated via a compiler, assembler, interpreter, or the like, which may or may not be included within the memory 404, so as to operate properly in connection with the operating system. Furthermore, the VRGI software 410 can be written with (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In at least one embodiment, the VRGI 410 is written entirely in Java, using a Robot class for the simulation of events. The VRGI 410 may also be implemented in hardware with one or more components configured to provide the desired functionality.

Additionally, while the game software 414 is illustrated as a software component stored in memory, this is also a nonlimiting example. More specifically, depending on the particular embodiment, the game may be embodied as an Internet game, as a hardware game inserted into a gaming console, and/or may be embodied in another manner.

The I/O devices 406 may include input devices such as, for example, a keyboard, mouse, scanner, microphone, sensor(s), VSR 100 components, VSR 100, etc. Furthermore, the I/O devices 406 may also include output devices such as, for example, a printer, display, audio devices, vibration devices, etc. Finally, the I/O devices 406 may further include devices that communicate both inputs and outputs such as, for instance, a modulator/demodulator (modem for accessing another device, system, or network), a radio frequency (RF) or other transceiver, a telephonic interface, a bridge, a router, etc.

When the computer 400 is in operation, the processor 402 may be configured to execute software stored within the memory 404, to communicate data to and from the memory 404, and to generally control operations of the computer 400 pursuant to the software. The VRGI software 410 and the operating system 412, and/or the game software 414 in whole or in part, but typically the latter, are read by the processor 402, perhaps buffered within the processor 402, and then executed.

It should be noted that the VRGI software 410 can be stored on any computer-readable medium for use by or in connection with any computer-related system or method. In the context of this document, a computer-readable medium is an electronic, magnetic, optical, or other physical device or means that can contain or store a computer program for use by or in connection with a computer related system or method. The VRGI software 410 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In an alternative embodiment, where the functionality of the VRGI software 410 is implemented in hardware, or as a combination of software and hardware, the functionality of the VRGI software 410 can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc; or can be implemented with other technologies now known or later developed.

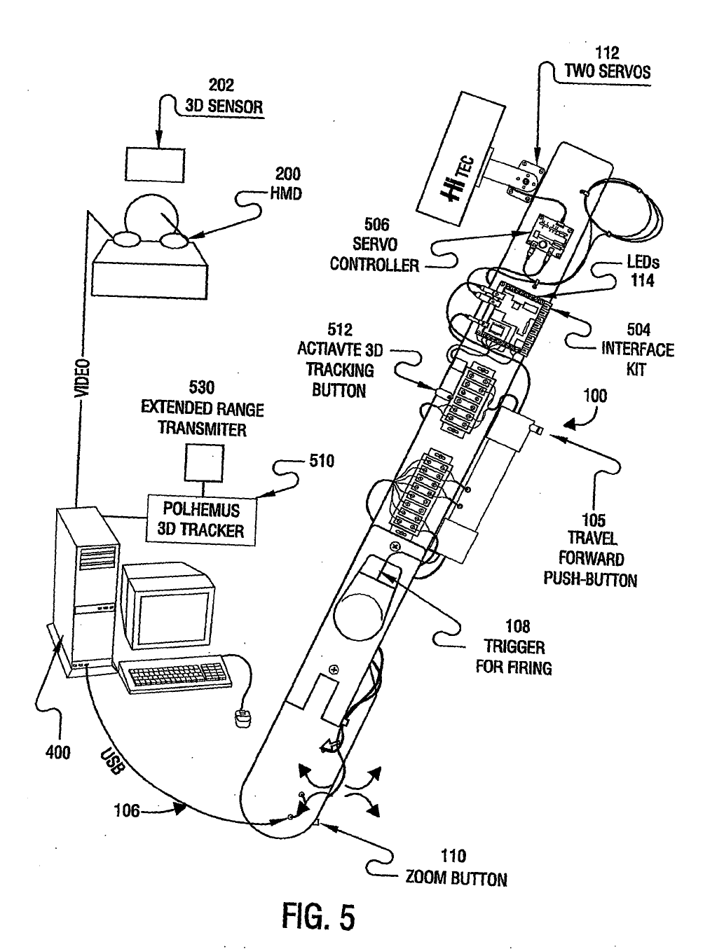

In at least one embodiment, the VR system can be implemented using a personal computer. The personal computer can be equipped with a video card that drives the HMD 200. In at least one embodiment, the HMD 200 includes i-glasses from i-O Display Systems. For tracking the yaw, pitch, and height of the user's head, a sensor of a Polhemus Fastrak 3D tracker can be used, which is equipped with an extended range transmitter. The user's head may be tracked by a 6DOF Polhemus sensor (see element 510, FIG. 5). The sensor is used to rotate the player's view in the virtual environment as well as for jumping and crouching the virtual self. The VRGI 410 interprets the input from the 3D tracker 510 and the buttons on the VSR 100 and sends corresponding keyboard and mouse events to the game. The game processes these key and mouse events as if the user was playing the game with a regular keyboard and mouse. The VRGI 410 monitors the user's head orientation (yaw and pitch) and height with a Polhemus 3D sensor 202 that is attached on the user's head. While the user rotates their head while being immersed, the VRGI 410 generates and sends mouse-moved events to the game so that the user's view rotates the equivalent amount they rotated their head in real life.

The VRGI software 410, shown in FIG. 4B, includes a plurality of logical components. As illustrated, the VRGI 410 includes an interface kit logic 420 that may be configured to receive an indication (such as from a Phidgets Interface Kit) when there is a change in the status of the buttons 104 (button press or release). The interface kit logic 420 may also be configured to control the LEDs 114 that reflect the status of the VSR 100. Additionally, the VRGI 410 may include a server controller 422, which may be configured to control the off-balance weight by sending commands to the servo controller that instructs the servos to rotate to simulate the vibration of a firing rifle. As discussed above, when the user activates the trigger buttons 108, the VSR may be configured to simulate firing an actual gun by changing the weight distribution of the VSR. To facilitate this effect, the VRGI 410 and, more specifically the server controller 422 may be configured to determine when such an event occurs and send a signal to one or more of the servo motors 112.

Also included in the VRGI 410 is a 3D tracker driver 424 that may be configured to read sensor data from Polhemus tracker, which may be included with the HMD 200, as discussed above. This data may be used for rotating the view, for jumping, crouching, and/or for other actions. Additionally included in the VRGI 410 is a simulator component 426. The simulator component 426 may be configured to use data from the other components 420-430, to generate desired key or mouse events and sends them to the game. More specifically, the simulator component 426 may be configured to translate the commands received from the VSR 100 into commands for the game software 414. Similarly, in embodiments where there is two-way communication between the VSR 100 (and/or the HMD 200) and the game software 414, a translation in the opposite direction may also be desired.

The VRGI 410 may be configured with two internal states, “active” and “inactive.” When in the active state, the VRGI 410 may be configured to generate key and mouse events continuously and as a result, the mouse may become inoperable. Similarly, when in active state, data from the 3D tracker 436 may be used to simulate mouse-moved events that control the user's view. When the VRGI 410 is in the inactive state, the VRGI 410 does not generate any key neither mouse events.

Initially, the VRGI 410 may be in an inactive state. During the inactive state, the game can be started (e.g., select the level to play, select level difficulty, etc.). When the user is ready, the VRGI 410 can be switched to the active state. There are two ways to switch states between active and inactive. One is via software, using a server software component 428 and/or a client software component 430 and the other is via a hardware push-button that is mounted onto the VSR 100.

More specifically, the server 428 may be used to read commands from the client 430 and pass them to the simulator component 426. The client 430, which may be run on a separate computer, is used to send commands to the server 428. These two components can be used during development to simulate discrete events such as moving the mouse to a specific position, simulate a specific key press, etc. Other commands include the instructions to the VRGI 410 to move to the active or inactive states. Also included is an interface 438, which may provide gaming and/or other options to a user.

FIG. 5 illustrates the VR system, including the HMD 200, the VSR 100, among other elements, similar to the diagram from FIG. 1. As shown in FIG. 5, the VSR 100 is connected to the host computer 400 via a connection, such as a USB cable 106. The USB cable 106 connects to the interface kit hardware 504 which is responsible for reporting the status of each button on the VSR 100, reflect the state of the VSR 100 using the LEDs 114 and connecting via its on-board USB hub to the servo controller.

Button events are sent from the interface kit 504 to the interface kit logic 420. When the fire button 108 is pressed, the VRGI 410 instructs the servo controller 506 to move the servo motors 112 back and fourth to provide the feeling of a firing weapon.

For jumping, crouching and controlling the orientation of the view, the VRGI 410 uses the information reported by the 3D tracker 510. For jumping and crouching the height information is used. At initialization, an internal variable is set to the user's height while standing. When the height information changes while the user is playing the game, and the difference is below a specified threshold (e.g., 40 centimeters), the virtual self crouches in the game. If the difference is above a specified threshold (e.g., 10 centimeters), the virtual self jumps in the game. For the orientation of the user's head, the yaw and pitch information of the 3D sensor can be used. Additionally, a push-button, shown in FIG. 5, labeled “Activate 3D tracking,” 512 is used to switch the VRGI 410 between its active and inactive states. An extended range transmitter 530 is also included and may be configured to create a high intensity electromagnetic field to increase the range of tracking sensors, such as the 3d sensor 202.

Designing a 3D traveling technique may be difficult, in general. The traveling technique is preferably effective, easy to learn, and user friendly. In at least one embodiment, the implementation of a traveling technique utilizes at least one input device. The input device is preferably natural to the user to use and also easy, so that the user does not have to remember to perform a specific coded gesture to change the speed of movement or the direction, for example. The interface becomes more complex when the movement technique provides multiple degrees of freedom. Because the VRGI 410 adds virtual environment functionality to existing 3D games, the degrees of freedom available to manipulate may be limited. Using the VRGI 410 does not require much additional training, which makes the VRGI 410 a user-friendly device. Novice users may need some training since the device is limited by the degrees of freedoms offered by the game.

The VRGI 410 may also be configured to provide at least the behavior implemented in a given game (e.g., require a mouse or a keyboard to make the character move forward). For instance, the avatar moves in the direction of the view and shoots in this direction. For this reason, when a game is played using the VRGI 410, the player may not be able to look one direction and shoot another direction (absent modification of the game engine). Thus, in such implementations using the VRGI 410, the user moves at the direction he or she is looking at. The user is free to look up, down, left and right by simply rotating his or her head in these directions. To move forward, the “travel forward” (shown in FIG. 5) button 105 is pressed; releasing this button stops the avatar from moving forward, and the user is still able to look around.

The “travel forward” button 105 is placed in the bottom-center of the VSR 100 so that when the user holds the VSR 100, this button is pressed. In some embodiments, the location of the button may be placed elsewhere.

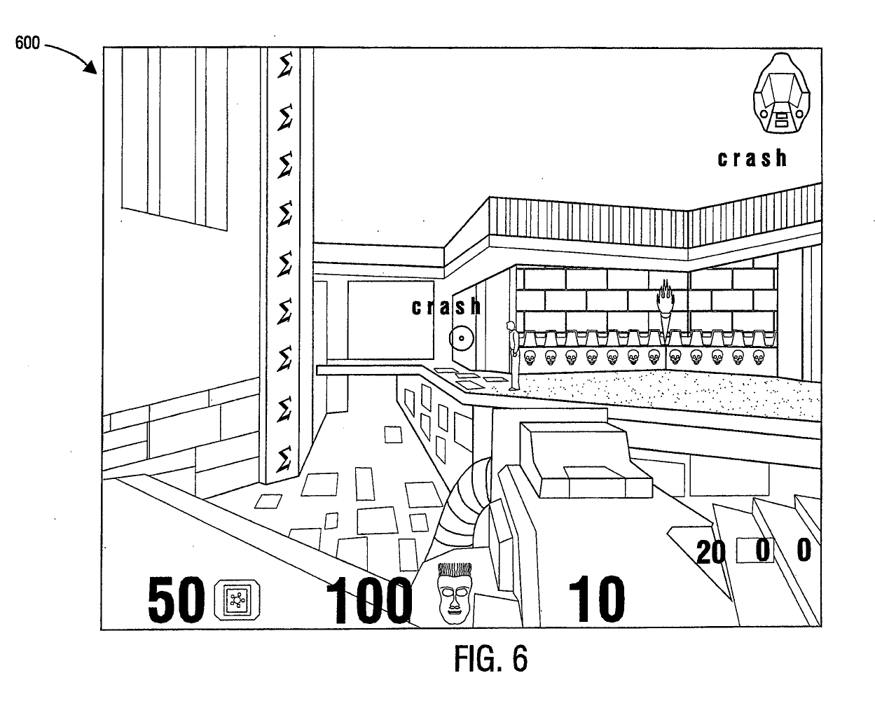

FIG. 6 is an illustration of interactive video game interface 600 used in one exemplary implementation. The 3D game used for evaluating the VRGI 410 is Quake III Arena, but the VRGI 410 may be configured to interface with other 3D first-person-view shooting games as well. The environment a user or users may be situated in to play a game according to the VR systems may vary. For instance, in one experiment, subjects played a game according to a VR system by standing next to the Polhemus transmitter, which was placed on a wooden base about 3.5 feet from the ground. Various obstacles (e.g., furniture and equipment) were removed to prevent distraction and signal distortion. The subjects had a short 5 minutes training session to become familiar with such features as the HMD 200, Polhemus 510 and the VSR 100's functionalities, among others. Each user played the “Q3DM3: Arena of Death” level (e.g., having multiple elevations and ledges), shown in FIG. 6, during their trials. Only one bot (‘Crash’) was enabled. The users played until they had killed Crash twice. Users could crouch behind barriers or jump onto ledges. During the practice sessions each user played the “Q3DM2: House of Pain” level with no bots.

The VR systems discussed herein enable people to play commercial, first-person-view shooting games in an immersive environment. The experimental results showed that playing the same game in an immersive environment may be slower than playing the same game the conventional way by using a mouse and a keyboard. Playing these games the conventional way using a keyboard and a mouse generally requires less effort from the user. A single keyboard press makes the avatar in the game jump, for example. Playing the same game in an immersive environment the user physically jumps while holding the relatively heavy device, the VSR 100. Simple mouse swings rotate the user, where in an immersive environment the user physically turns around. However, even though the performance may be of a lower quality when playing a game in an immersive environment, as opposed to playing the same game the conventional way, experiments show that the subjects enjoyed the game more.

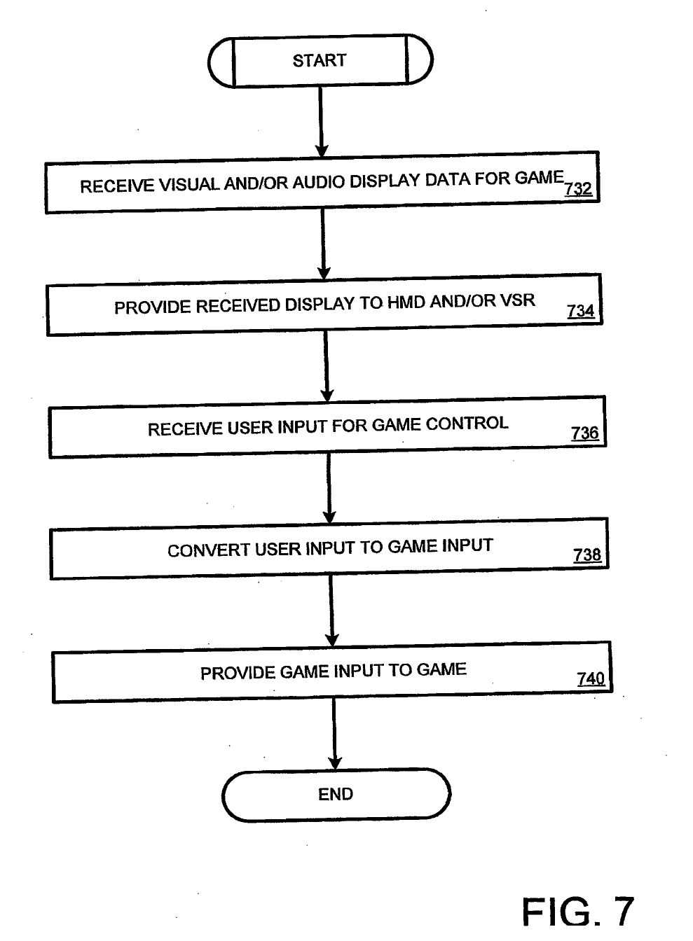

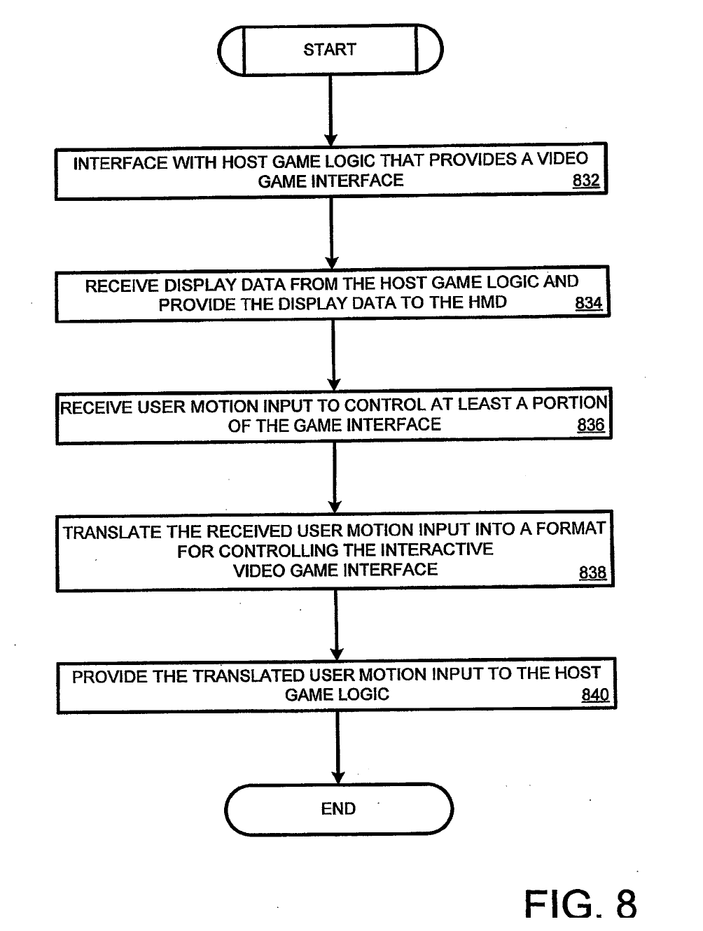

FIG. 8 depicts a flowchart illustrating a process that may be utilized for providing virtual reality controls, such as described with reference to FIG. 5. As illustrated in the nonlimiting example of FIG. 7, the VRGI 410 may be configured to receive visual and/or audio display data for a game (block 732). As discussed above, the VRGI 410 may also be configured to provide the received display data to the HMD 200 and/or VSR 100 (block 734). The VRGI 410 may also be configured to receive user input for game control from the HMD 200 and/or VSR 100 (block 736). More specifically, as described above, the VRGI 410 can receive position data, trigger data, motion data, and/or other control data for controlling the game.

The VRGI 410 can convert the received user input to game input (block 738). More specifically, as discussed above, the VRGI 410 may be configured to determine game input controls, which may include inputs received via a keyboard, mouse, game controller, etc. Upon determining the game inputs, the VRGI 410 can associate the game inputs with received inputs from the HMD 200 and/or VSR 100. Upon receiving inputs from the HMD 200 and/or VSR 100, the VRGI 410 can convert this data into data recognizable by the gaming software. The VRGI 410 can provide the converted game input to the gaming software (block 740).

FIG. 8 depicts a flowchart illustrating a process for providing user motion input to a host game, similar to the flowchart from FIG. 7. As illustrated in the nonlimiting example of FIG. 8, the VRGI 410 can interface with host game logic 414 that provides a video game interface 600 (block 832). More specifically, as discussed above, the host game logic 414 may be configured to provide an interactive video game for play by the user. The VRGI 410 can receive display data from the host game logic 414 and provide the display data to the HMD 200 (block 834). The HMD 200 can display the provided display data as video and/or audio for game play. The VRGI 410 receives user motion input to control at least a portion of the game interface (block 836). The data may be received from the VSR 100, the HMD 200 and/or from other sources. More specifically, the user motion can include shooting actions, zoom actions, movement actions, and/or other actions. As discussed above, the VRGI 410 can receive this user motion input for simulation of that motion in the video game interface 600 (e.g., when the user shoots, the character shoots; when the user aims, the character aims and zooms, etc.).

The VRGI 410 can translate the received user motion input into a format for controlling the interactive video game interface 600 (block 838). The VRGI 410 can provide the translated user motion input to the host game logic (block 840).

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, as in an alternative embodiment embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

What is claimed:

1. A virtual reality method, comprising:
interfacing with host game logic, the host game logic configured to provide an interactive video game interface;
receiving display data from the host game logic, and provide the display data to a virtual reality head mounted display;
receiving user motion input to control at least a portion of the interactive video game interface, the user motion input being provided via a virtual simulation device, the virtual simulation device configured to facilitate control of at least a portion of the interactive video game interface via simulation of user motion;
translating the received user motion input into a format for controlling the interactive video game interface; and
providing the translated user motion input to the host game logic.

2. The method of claim 1, further comprising receiving user motion input from the virtual reality head mounted display.

3. The method of claim 2, wherein receiving user motion input from the virtual reality head mounted display includes receiving at least one of the following: crouching input, jumping input, and head turning input.

4. The method of claim 1, wherein the virtual simulation device is embodied as a virtual simulated rifle.

5. The method of claim 4, wherein the virtual simulated rifle includes at least one of the following: a trigger button, a travel forward button, a zoom button, and at least one servo motor.

6. The method of claim 4, wherein the virtual simulated rifle is configured to provide tactile simulation to simulate firing of a rifle.

7. The method of claim 1, wherein the virtual simulation device is configured for at least one of the following: wireline communication and wireless communication.

8. A virtual reality system, comprising:
an interface component configured to interface with host game logic, the host game logic configured to provide an interactive video game interface;
a first receive component configured to receive display data from the host game logic, and provide the display data to a virtual reality head mounted display;
a second receive component configured to receive user motion input to control at least a portion of the interactive video game interface, the user motion input being provided via a virtual simulation device, the virtual simulation device configured to facilitate control of at least a portion of the interactive video game interface via simulation of user motion;
a translate component configured to translate the received user motion input into a format for controlling the interactive video game interface; and
a provide component configured to provide the translated user motion input to the host game logic.

9. The system of claim 8, further comprising a third receive component configured to receive user motion input from the virtual reality head mounted display.

10. The system of claim 9, wherein the first receive component is configured to receive at least one of the following: crouching input, jumping input, and head turning input.

11. The system of claim 8, wherein the virtual simulation device is embodied as a virtual simulated rifle.

12. The system of claim 11, wherein the virtual simulated rifle includes at least one of the following: a trigger button, a travel forward button, a zoom button, and at least one servo motor.

13. The system of claim 11, wherein the virtual simulated rifle is configured to provide tactile simulation to simulate firing of a rifle.

14. The system of claim 8, wherein the virtual simulation device is configured for at least one of the following: wireline communication and wireless communication.

15. A virtual reality computer readable storage medium, comprising:
interfacing logic configured to interface with host game logic, the host game logic configured to provide an interactive video game interface;
first receiving logic configured to receive display logic configured to display data from the host game logic, and provide the display data to a virtual reality head mounted display;
second receiving logic configured to receive user motion input to control at least a portion of the interactive video game interface, the user motion input being provided via a virtual simulation device, the virtual simulation device configured to facilitate control of at least a portion of the interactive video game interface via simulation of user motion;
translating logic configured to translate the received user motion input into a format for controlling the interactive video game interface; and
providing logic configured to provide the translated user motion input to the host game logic.

16. The computer readable storage medium of claim 15, further comprising third receiving logic configured to receive user motion input from the virtual reality head mounted display.

17. The computer readable storage medium of claim 16, wherein the first receiving logic is configured to receive at least one of the following: crouching input, jumping input, and head turning input.

18. The computer readable storage medium of claim 15, wherein the virtual simulation device is embodied as a virtual simulated rifle.

19. The computer readable storage medium of claim 18, wherein the virtual simulated rifle includes at least one of the following: a trigger button, a travel forward button, a zoom button, and at least one servo motor.

20. The computer readable storage medium of claim 18, wherein the virtual simulated rifle is configured to provide physical motion to simulate firing of a rifle.
